(19) United States
(12) Patent Application Publication
(10) Pub. No.: US 2017/0300838 A1
(43) Pub. Date: Oct. 19, 2017

(54) Method and System for Service Exchange Optimization

(71) Applicant: Leonard Bertelli, Lenox, MA (US)

(72) Inventor: Leonard Bertelli, Lenox, MA (US)

(21) Appl. No.: 15/097,668

(22) Filed: Apr. 13, 2016

(51) Int. Cl. G06Q 10/06; H04L 29/08; H04L 12/725

(52) U.S. Cl. CPC G06Q 10/0631; H04L 45/30; H04L 67/18

(57) ABSTRACT

A method, computer program product, and apparatus for providing the exchange of transportation services between separate company entities are provided. Transportation services are received from a communications device. Primary geographical location information of where the service is to be performed is received from the communications device. What is new is that the system automatically combines service data from all companies and analyzes them together to find the most optimized transportation methods. Opportunities to exchange optimized services are transmitted to the communications device. Opportunities, which contain the net profit improvements, are transmitted to the communications device for the company that may provide the service. Opportunities, which contain cost improvements, are transmitted to the communications device for the company the service is being performed for. Agreements for exchanged services are transmitted to the communications device.

### CROSS-REFERENCE TO RELATED APPLICATIONS

A Provisional Patent was filed 14 Apr. 2015 with application No.: 62/147,015 under the Title “Process and system for Service Exchange Optimization”.

### STATEMENT REGARDING FEDERALLY SPONSORED RESEARCH OR DEVELOPMENT

This invention was not made with government support. The government has no rights in the invention.

### THE NAMES OF THE PARTIES TO A JOINT RESEARCH AGREEMENT

This invention is not part of a joint research agreement. All elements of this invention were developed and are owned by the Inventor of this application (Leonard Bertelli).

### BACKGROUND OF THE INVENTION

This application claims priority from U.S. provisional application 62/147,015 filed Apr. 14, 2015 and relates to a method and system for the service exchange between companies (and/or other third parties, such and service brokers), which is preferably implemented through an Internet web site. The entire disclosure contained in U.S. provisional application 62/147,015, including the attachments thereto, is incorporated herein by this reference.

Companies optimize their operations within the boundaries of their own specific capabilities. In some cases companies will outsource some of their core operations to reduce cost but they expend substantial time and resources in arranging the exchange. Finally, after careful manual analysis, both business parties enter into an agreement to outsource the service. Rarely will both companies aggregate their services to provide universal analysis for further optimization.

Conventional trading systems such as auctions or reverse-auction systems are typically designed for customer-to-vendor relationships and do not provide connections between companies based on optimization. Further, these systems are not well suited for peer-to-peer exchanges of services for outsourcing services and are not based on universally optimizing cost or operations.

The present invention is in the technical field of business-to-business systems. More particularly, the present invention is in the technical field of a trading system for outsourcing services.

The related art U.S. Pat. No. 8,566,214 B2 titled “Method, Computer Program Product, and Apparatus for Providing Reverse Auction Transport Services”. This invention does not lend itself to exchanging services in a business-to-business relationship but is designed for a business-to-consumer relationship. Further, this invention only initiates its method on requests from a user and does not automatically initiate its own method for continuous improvement. Further, this invention does not provide optimization and analysis as a function of its system to analyze both parties' operational needs together and determine the best match for both.

### SUMMARY OF THE INVENTION

The present invention is a system intended to find efficiencies for services owned by distinct companies and analyzing companies' data together as if they were part of the same entity. These services can then be exchanged between companies. Companies do well at optimizing their operations internally but inter-company optimization is highly manual if done at all. The present invention automates and facilitates inter-company optimization while maintaining the information barrier preventing exchanges or communication that could lead to conflicts of interest commonly known as a “Chinese Wall”.

This system includes the process for managing lists of service definitions of customers. These service lists are then aggregated from multiple companies for universal analysis. The analysis on the combined list will produce subset lists based on matching service needs such as but not limited to being based on a service schedule. Optimization is then achieved through analysis via algorithms that are specific for the type of services being analyzed. For example transportation services may use spacial analysis and routing algorithms while storage services may use nesting algorithms.

### BRIEF DESCRIPTION OF THE SEVERAL VIEWS OF THE DRAWING

Referring now to the drawings wherein like elements are numbered alike in the several FIGURES:

FIG. 1 illustrates a diagram of a system in which a service exchange service may be implemented in accordance with exemplary embodiments.

FIG. 2 illustrates the data elements that are used to support a service exchange system.

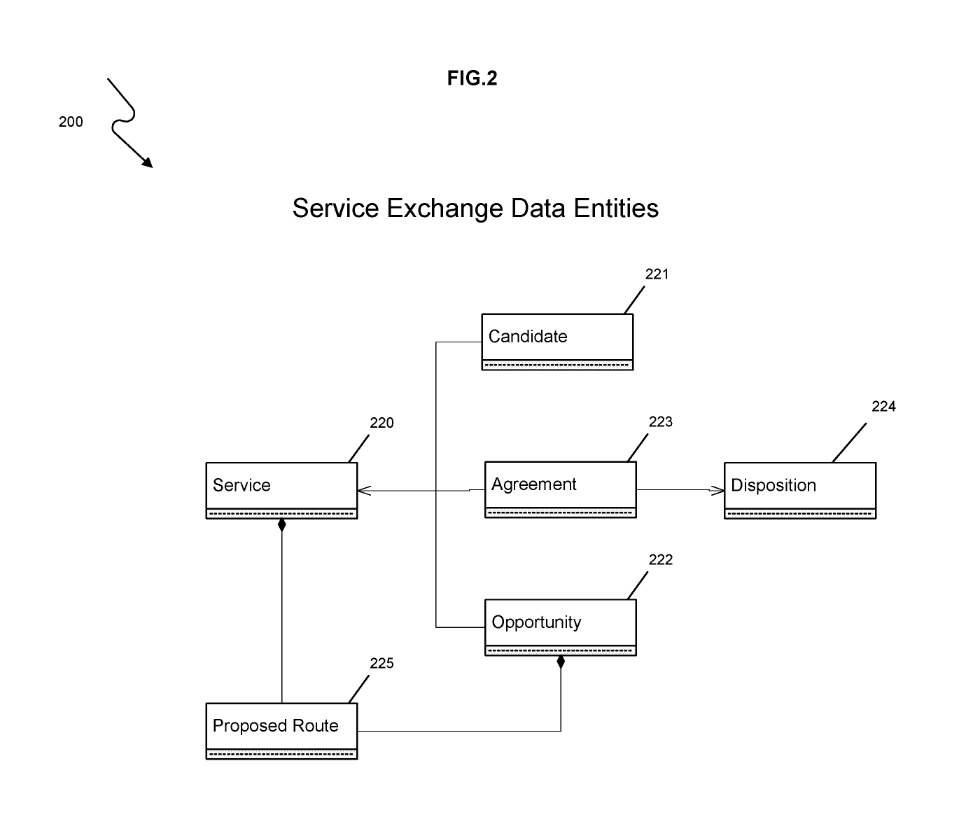

FIG. 3 illustrates a non-limiting example of a transportation service savings table in accordance with exemplary embodiments.

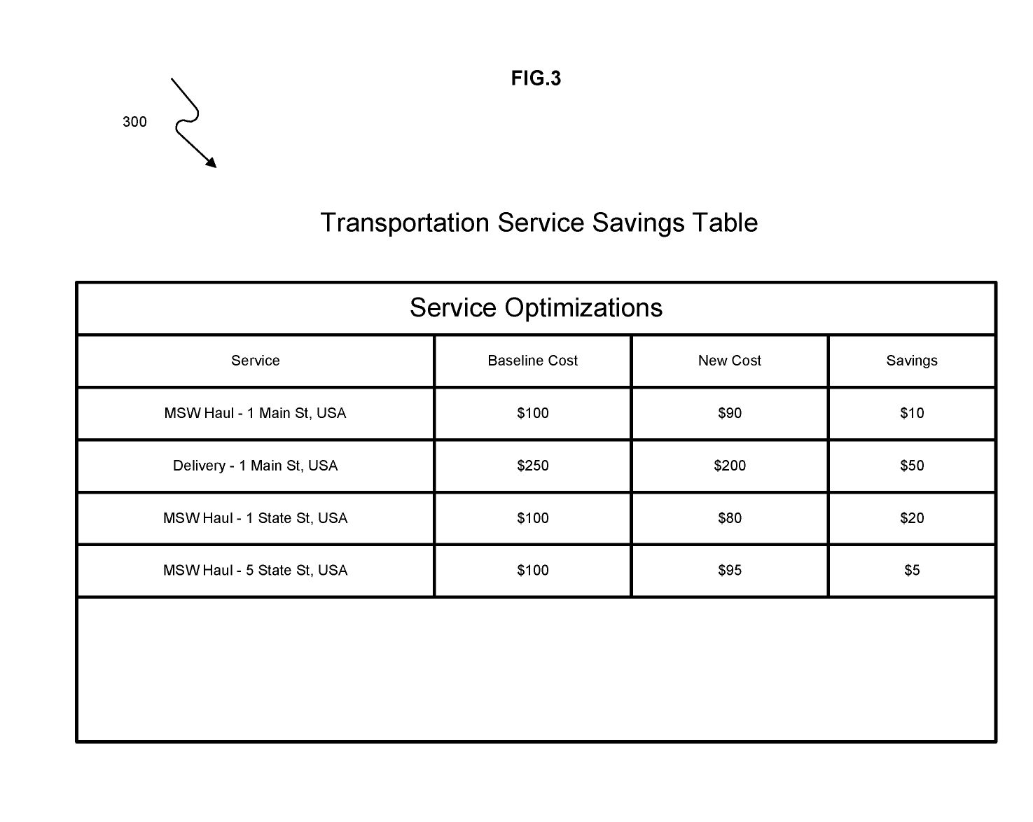

FIG. 4 illustrates a non-limiting example of a transportation service opportunities table in accordance with exemplary embodiments.

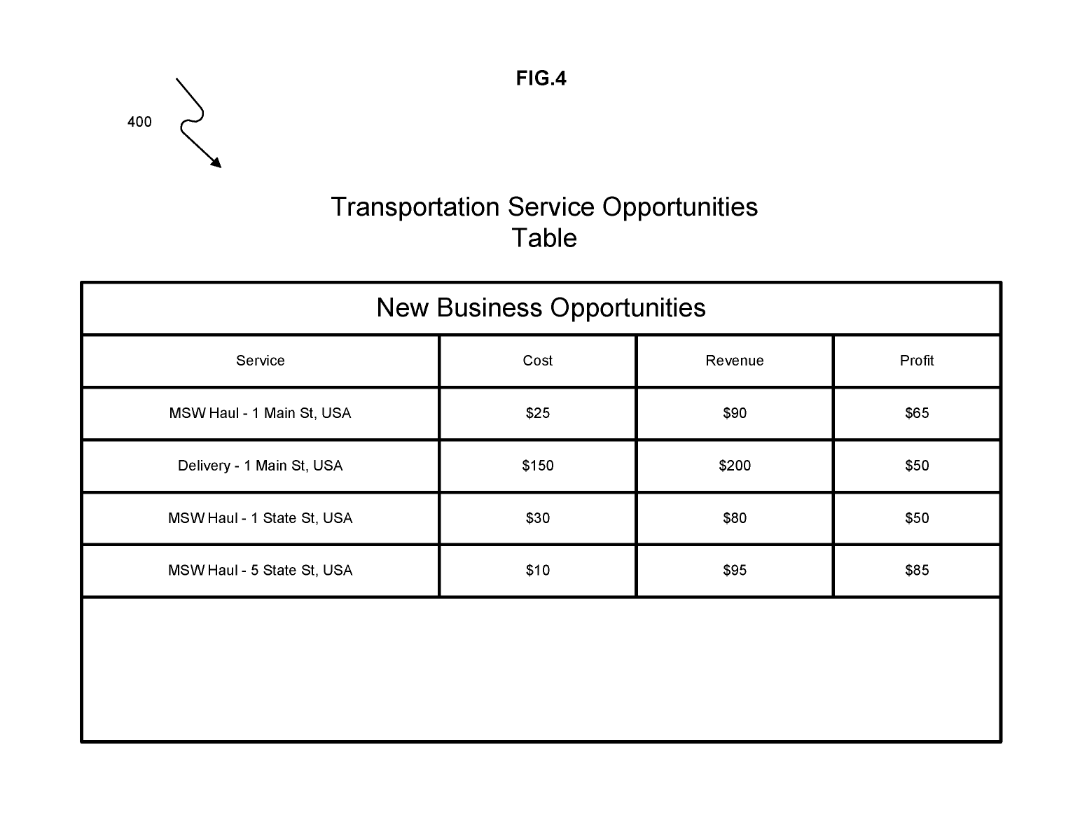

FIG. 5 illustrates a non-limiting example of a proposed route table in accordance with exemplary embodiments.

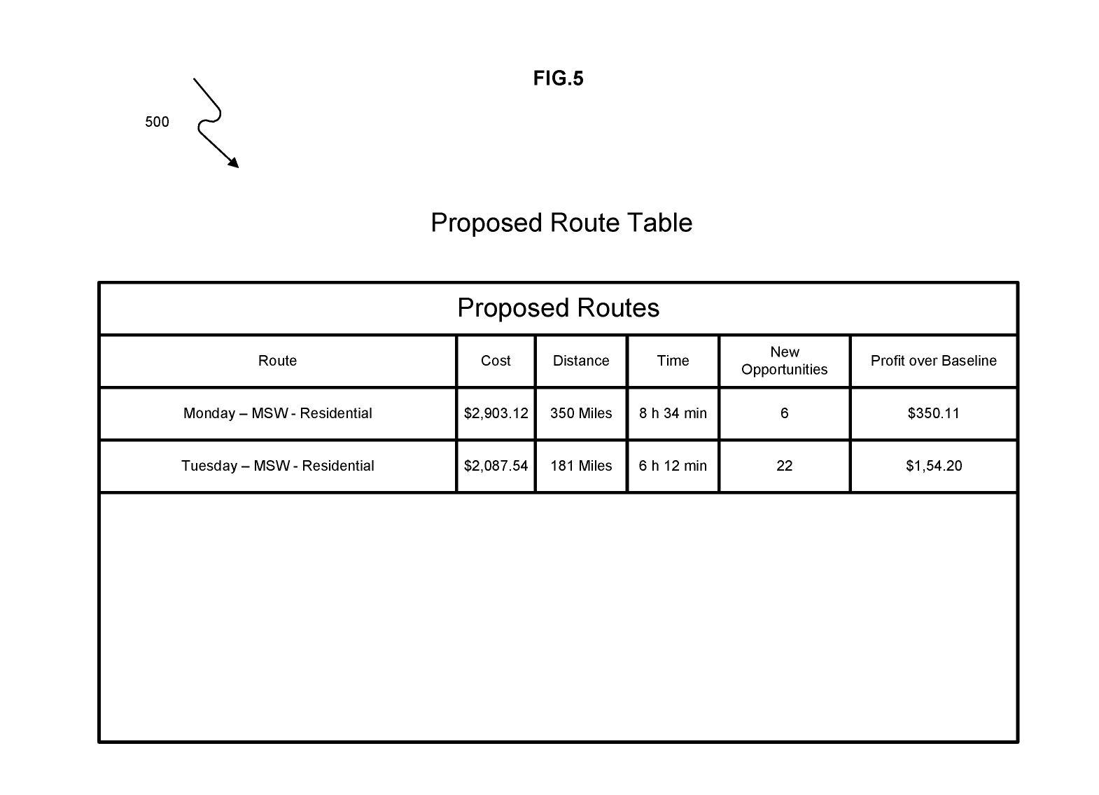

FIG. 6 illustrates a method of providing a transportation service exchange system.

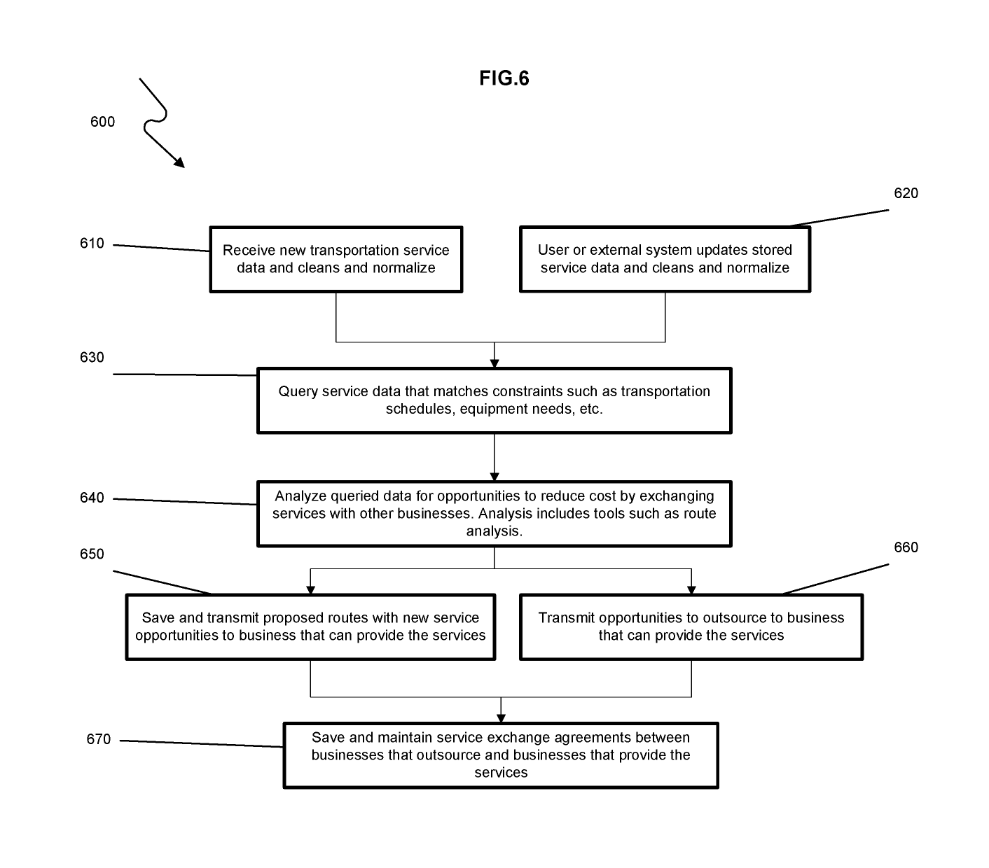

### DETAILED DESCRIPTION

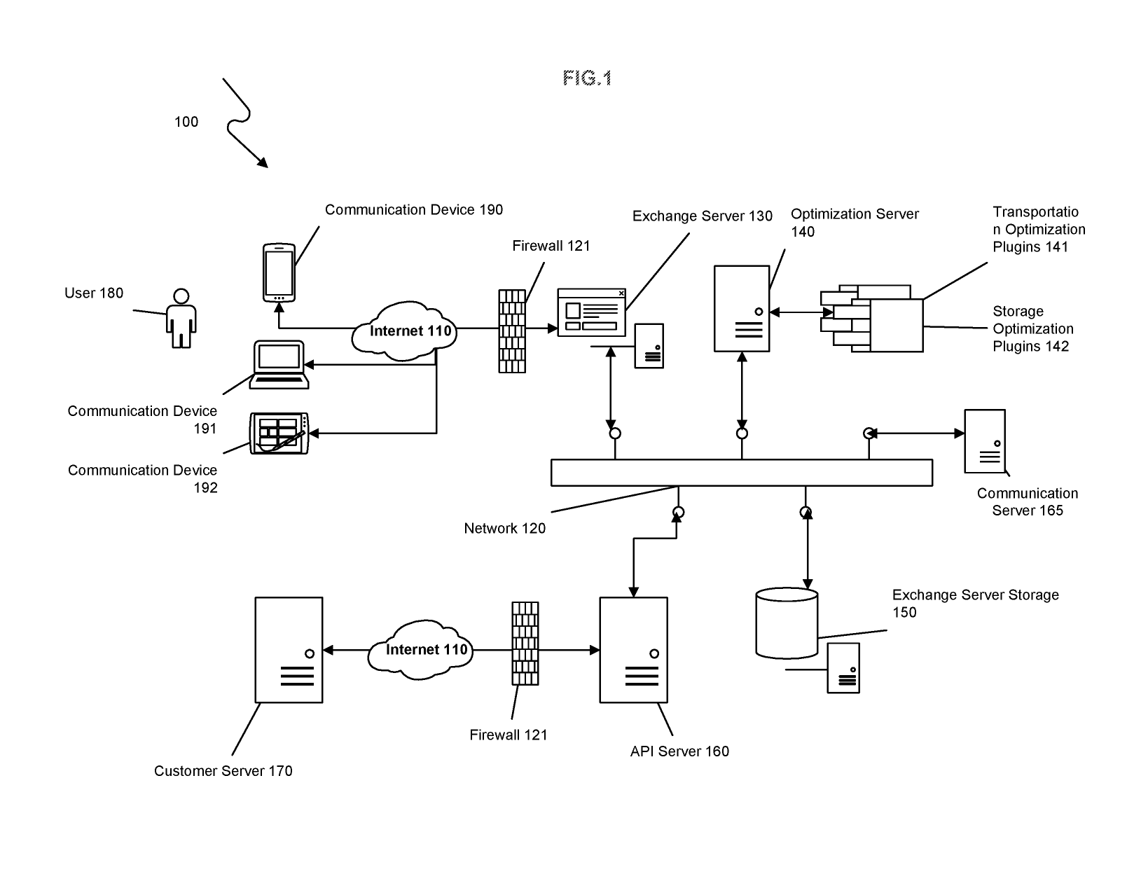

FIG. 1 is a schematic representation of the computer network associated with a preferred embodiment of the method and system of the present invention. Specifically, each individual user associated with a company has access to the Internet 110. Via the Internet 110, companies can access a web server 130 hosting the web site of the method and system of the present invention. However, as shown in FIG. 1, to protect the web server 130 from unauthorized access, the server 130 is preferably secured behind a firewall 121.

Associated with the web server 130 is an integral database 150, which is the storage location for all data about users and companies of the system, along with all pertinent data and information associated with the services 220, analysis, and exchange process. The specific architecture and design of this database is not essential to the method and system of the present invention provided that the database can meet the storage and retrieval requirements set forth herein. Various commercial software packages and/or programming techniques could be used by those skilled in the art to develop this database without departing from the spirit and scope of the present invention.

Lastly, with respect to the schematic representation of FIG. 1, one or more servers 140 160 165 may provide direct access to the web server 130 and associated integral database 150.

The most widely used portion of the Internet is the World Wide Web (“WWW”) which provides for navigation through the selection of, or “clicking” of, hypertext images and text. Such hypertext images and text are an important feature of standard Hypertext Markup Language (HTML), the programming language that forms the backbone of the WWW. To carry out execution of the routines and subroutines of the preferred system as described herein, it is understood that standard Hypertext Markup Language (HTML) and associated programming languages and techniques would be used. With benefit of the following description, such programming is readily accomplished by one of ordinary skill in the art.

FIG. 1 illustrates a system 100 that optimizes business operations for services 220 from distinct companies when analyzed together. Examples of service types include transportation and storage. This invention has two parts. The first is to identify the opportunities to optimize operations 140 across company boundaries via analysis on multi-company aggregated data. The second is an exchange system 130 to manage the inter-company exchange of said services.

Prior to viewing the various components and features of the preferred method and system as implemented through an Internet web site, the operation of the method and system is best explained by an example:

ABC Company is a waste hauler who picks-up waste from several customers and dumps the waste into one or more landfills. Each of these customers has a service 220 that defines the specific needs for a waste hauler to perform the waste removal. Users in ABC Company prepares its list of customer services in electronic form and uploads or enters them in manually 610 620 and for viewing through the Internet web site 130 implementing the method and system of the present invention. Specifically, services 220 are stored in an integral database 150 resident on the Internet-accessible web server 130.

Through the Internet web site 130, participating waste haulers can view each and every detail of their services 220, including locations, baseline costs, types of material, pick-up schedule, etc. Moreover, participating waste haulers can quickly and easily filter and/or sort service 220 information, viewing only services meeting certain criteria, such as area, location, mileage, and/or equipment. Through such filtering and sorting techniques, each waste hauler can identify which services 220 it would like routed, and which services it would like to be considered for optimization/outsourcing with/to other waste haulers. After making such determinations, rather than preparing a complete manually written outsource package, each waste hauler can receive automatically generated optimized routes 225 500 and cost saving outsource opportunities 300 from the system, via a communication device such as the web site 130 interface or asynchronous message 165.

If two companies wish to participate in the exchange, each company can execute and monitor the agreement 223 through the web site 130. As ABC Company continues to gain new business or loose business the system will continually and automatically search for new opportunities to optimize 630 640. Furthermore, with respect to current business, ABC Company can compare proposed routes 225 with existing routes. Agreements 223 persist until they are automatically terminated when their effective dates expire. Through the same web site interface 130, both companies can terminate specific agreements 223 or have agreements terminate automatically by new outsourced agreements.

In this regard, depending on company preferences, the method and system of the present invention conducts the automated selection process though a “most efficient” algorithm 640 or in a quasi-reverse auction format. Specifically, a company wishing to receive new outsource business may choose to lower their profit goals to view information associated with more opportunities 222 to widen their availability via the web site 130 to create a “fishing” process. In any event, most companies have a variety of selection criteria and preferences with respect to increasing the scope of opportunities, and, as such, lower overhead does not guarantee a more efficient company to gain specific business.

An explanation of the various components and features of the preferred method and system as implemented through an Internet web site, the operation of the method and system is explained here:

The exchange system 130 is software that will allow companies to manage 610 620 their service 220 data by transmitting to the communications device via the Internet 190 191 192 110 and exchange services with other companies. This can be done either by a human user 180 through a user interface or by via a company's system 170 through an API 160. The system will allow companies to manage their data by:
Loading in existing service data 620 or creating new ones 610
Edit services or delete them 620
Cleanse data 610 620 to correct elements such as but not limited to addresses & geographic positions.
Normalize their data 610 620 into a format that is standard across all participating companies

The system has an optimization analysis server 140 that will use criteria to identify what services have the potential to be exchanged. A list of matching 630 services called candidates 221 will be created from this criterion. The criteria for which services can be analyzed consists of but is not limited to:
Schedule (one-time or reoccurring)
Capabilities of equipment needed to perform the Service
The physical requirements of the Service (location to be performed, dimensions, weight)
Material or product attributes

A service has a single location where the service 220 has significance. A service may have an optional disposition 224, which is where the service 220 may start or end but is not important to the service itself. An example for a waste collection operation, which has a service 220. that has an end disposition 224 associated where the primary location is Where the waste needs to be picked-up but the disposition 224 is of little consequence as it can go to any landfill. Another example is of a fuel distribution operation where a service 220 has a start disposition 224 associated and the primary location is where the fuel needs to be delivered but the start disposition is of little consequence as it can come from any fuel depot. An example of a service 220 that has no disposition 224 is a snow plowing service where the primary location is where the truck needs to plow but there is no start or end location.

A second analysis 640 will determine if there is a benefit for a service 220 (or subsets of services) to be performed by another company. The benefit analysis 640 will use a number of tools and criteria that are dependent on the service 220 type. The benefit analysis 640 will use the optimization server 140, which in turn uses pluggable software 141 and 142 that are algorithms and processes specific to a particular service type. For transportation type services a company's services transportation costs will be calculated with a routing algorithm that will combine candidate 221 service locations from other companies with their own. The analysis will also consider disposition 224 scenarios to find the best distribution network for further optimization. The criteria for analysis consists of but is not limited to:
Cost per distance unit (Kilometer)
Cost per stop (Kilometer)
Cost per time (Hour)
Cost per time per stop (Hour)

The system will then 150 the lowered cost services as opportunities 222 300 400 to be subsequently used by the system's exchange system 130. The system will also save 150 proposed routes 225 500 that were used as part of the analysis to determine best cost and operational efficiency gains. The system will also transmit the results to the appropriate company 650 660.

The system will restrict access to data so that each company will only see their own information. The system will leverage the optimization analysis 640 to automatically identify opportunities where services could be exchanged between companies. These are transmitted 650 660 165 as opportunities 222 to the receiving company with only the absolute necessary information provided to accept the exchange.

The system will allow both parties to accept 670 an opportunity 222 to exchange a service 220 through an agreement 223. Agreements 223 will have details that define their financial details, duration, and other contractual aspects of the deal.

The system will persist 150 and maintain 670 opportunities 222 and agreements 223 to perform historical analysis on business performance, performance against peers, system performance, and other metrics.

The system has a communication server 165 that can be used to send asynchronous messages consisting of but not limited to email, SMS, and publish and subscribe technologies.

What is claimed is:

1. A method for generating a list of services that are optimized for exchange between companies, the method comprising:
in response to receiving, from a communications device, geographical location information of a service, its constraints, and a disposition which may include a destination location in a request to finalize a service or a location to start a service and
in response to an automated computer task, from the automated system continuously performing background improvement analysis, from persisted geographical location information of a service, its constraints, and a disposition which may include a destination location, that is initiated by the system
generating a table to transmit to or make available on their communication devices or their system, to the company that has an opportunity to provide service(s), to contain their opportunities which will contain the net profit improvement analysis
generating proposed routes to transmit to or make available on their communication devices or their system, to the company that has an opportunity to provide services, in a proposed route combined with the opportunities derived by the system, to contain aggregated net profit improvement analysis
generating a table to transmit to or make available on their communication devices or their system to the company that has an opportunity to outsource service(s), to contain their opportunities which will contain the cost improvement analysis
maintaining a table to contain the service agreements for exchanges between the companies to establish baselines for cost, profit, operational efficiency analysis, and maintaining new affinities for future service routing and analysis

2. The method for claim 1, further comprising transmitting to the communications device the table of opportunities Which contain the net profit improvement analysis

3. The method for claim 1, further comprising transmitting to the communications device the proposed routes which contain aggregated net profit improvement analysis

4. The method for claim 1, further comprising transmitting to the communications device the table of opportunities which contain cost improvement analysis

5. The method for claim 1, further comprising transmitting to the communications device the table of agreements held between the companies of exchanged services
